(19) United States
(12) Patent Application Publication
(10) Pub. No.: US 2026/0298740 A1
(43) Pub. Date: Oct. 1, 2026

(54) MAST MOMENT SENSING FOR AN AIRCRAFT

(71) Applicant: Archer Aviation Inc., San Jose, CA (US)

(72) Inventor: Alan Buehne, Mission Viejo, CA (US)

(21) Appl. No.: 18/880,491

(22) PCT Filed: Jul. 18, 2023
(86) PCT No.: PCT/US23/70369

§ 371 Date: Dec. 31, 2024

Related U.S. Application Data
(60) Provisional application No. 63/390,999, filed on Jul. 21, 2022.

(51) Int. Cl. G01L 1/24; B64C 29/00; B64D 45/00; G01L 5/00

(52) U.S. Cl. CPC G01L 1/246; B64C 29/0033; G01L 5/0009; B64D 2045/0085

(57) ABSTRACT

In one embodiment described herein is a mast moment sensor system for a rotorcraft comprising a rotor shaft bearing strain sensor. In some embodiments the mast moment sensor system is configured to compute a rotor mast moment using the rotor shaft bearing strain information. In one embodiment herein the rotor shaft bearing strain sensor comprises a fiber optic strain sensor.

This application is a US national stage entry of PCT/US23/70369, filed on Jul. 18, 2023, which claims priority to U.S. provisional application having Ser. No. 63/390,999, filed Jul. 21, 2022. These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aircraft monitoring.

### BACKGROUND

Monitoring mast moment is important in rotorcraft with rigid rotors because large mast moments can cause sudden changes in aircraft attitude. Rotor mast moment information can both warn of a dangerous condition as well as characterize the attitude of the aircraft.

Conventional mast moment sensors can be complex and unreliable. Many conventional mast moment sensing systems use complex optical systems that occupy large amounts of space. The systems are often packaged inside complex powertrain assemblies-rendering the mast moment sensing system difficult to maintain or replace.

### SUMMARY

Mast moment is monitored in one aspect herein using a fiber optic strain sensor configured to measure strain around the proprotor shaft bearings.

### BRIEF DESCRIPTION OF THE DRAWINGS

FIG. 1 illustrates an aircraft comprising an embodiment of a mast moment sensing system.

FIG. 2 illustrates a cutaway view of a propulsion system comprising an embodiment of a mast moment sensing system.

FIG. 3 illustrates a detail view of aspects of the propulsion system of FIG. 2.

FIG. 4A illustrates a diagram of a bearing sleeve in an unstrained state.

FIG. 4B illustrates a diagram of a bearing sleeve in a strained state.

FIG. 5 illustrates a different embodiment of a mast moment sensing system implemented in a rotor system comprising a gearbox.

FIG. 6 illustrates methods for determining the mast moment of a propulsion system.

FIG. 7A illustrates a different embodiment of a bearing sleeve and aspects of a fiber optic strain sensor.

FIG. 7B illustrates a section of the bearing sleeve and fiber optic strain sensor aspects of FIG. 7B.

FIG. 8 illustrates an isometric view of the same bearings sleeve and fiber optic strain sensor aspects of FIG. 7A.

FIG. 9 illustrates an isometric view of aspects of the same propulsion system as the embodiment of FIG. 2.

### DETAILED DESCRIPTION

The problem is solved in one aspect herein using a fiber optic strain sensor configured to measure strain around the proprotor shaft bearings.

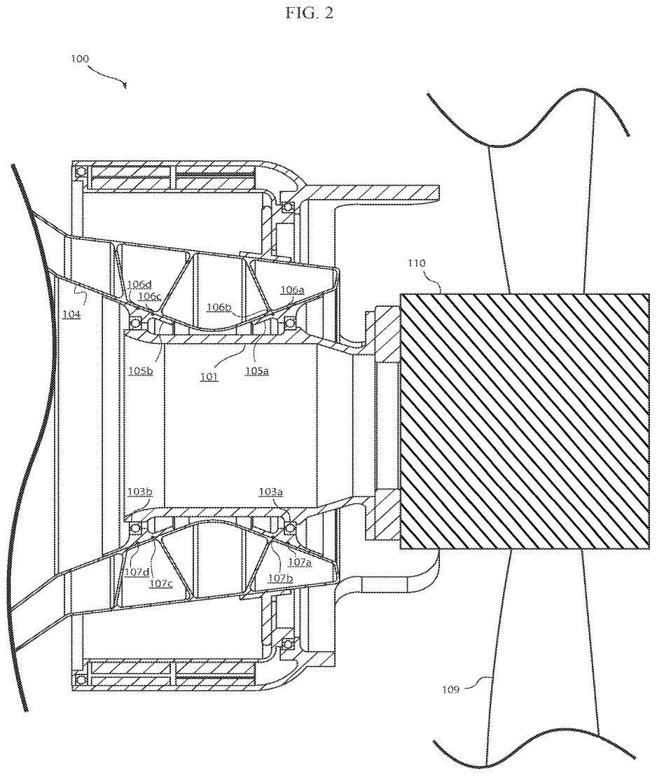

Fiber optic strain sensors-as implemented in some embodiments herein-can be robust and simple. The embodiment of FIG. 2 comprises a mast moment sensing system without any moving pieces.

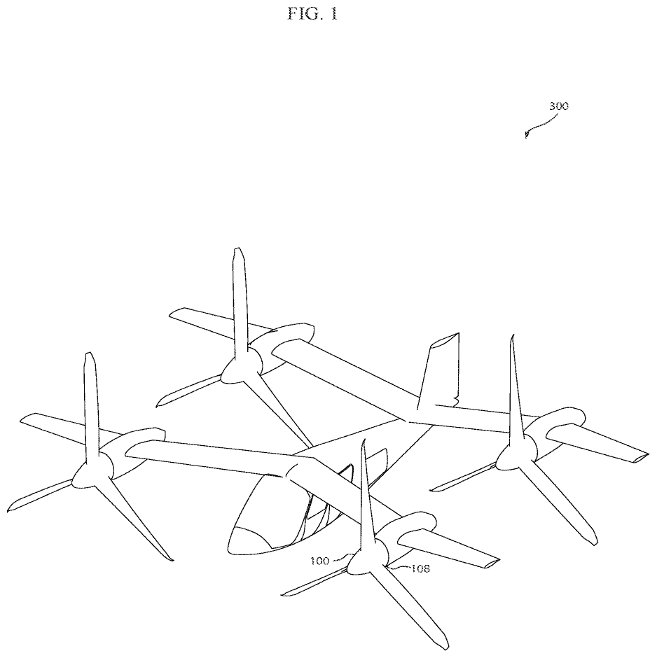

Illustrated in FIG. 1 is tiltrotor aircraft 300 comprising a mast moment sensing system 108. The aircraft 300 of FIG. 1 comprises an electric vertical takeoff and landing (eVTOL) tiltrotor aircraft. However, other embodiments of the mast moment sensing system can be configured for use in any other type of aircraft.

FIG. 2 illustrates proprotor propulsion system 100 comprising an embodiment of a mast moment sensing system. The proprotor propulsion system 100 comprises a proprotor shaft 101 connecting proprotor hub 110 to hub shaft bearings 103a and 103b. Nacelle structure 104 is shown. Interposed between the nacelle structure 104 and the main hub shaft bearings 103a and 103b are bearing sleeves 105a and 105b. The bearing sleeves 105a and 105b comprise grooves 106a, 106b, 106c, and 106d configured to accommodate fiber optic strain sensor cables 107a, 107b, 107c, and 107d. Fiber optic strain sensing cable 107a and 107b are configured to measure the strain of bearing sleeve 105a. Fiber optic strain sensing cables 107c and 107d are configured to measure the strain on bearing sleeve 105b. The fiber optic strain sensing cables 107a and 107b are wrapped around bearing sleeve 105a. Fiber optic strain sensing cables 107c and 107d are wrapped around bearing sleeve 105b.

Embodiments of the presently described mast moment sensing system can have particular advantages when incorporated with embodiments of the propulsion system described in PCT/US22/13272, filed Jan. 21, 2022, and U.S. Provisional Application 63/140,515, filed on Jan. 22, 2021, which are incorporated by reference herein in their entirety.

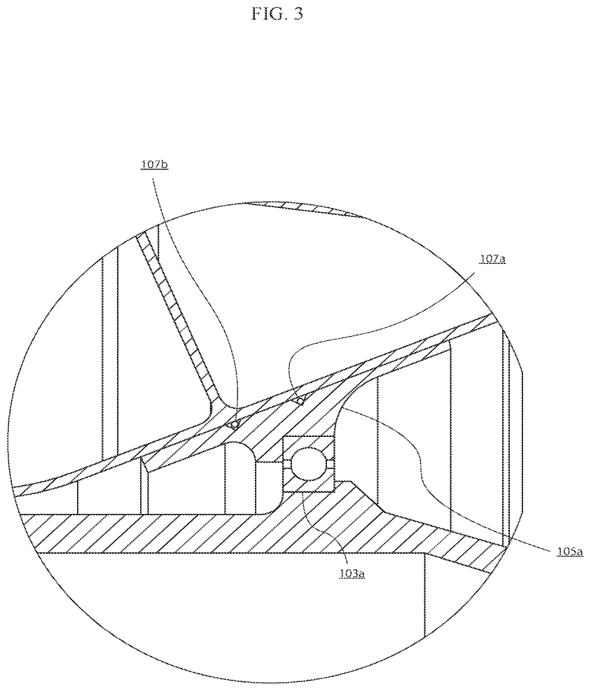

FIG. 3 illustrates a detail view of aspects of the proprotor propulsion system of FIG. 2. Fiber optic strain sensing cables 107a and 107b are shown. Also shown are hub shaft bearings 103a and bearing sleeve 105a.

In the embodiment of FIG. 2, hub shaft bearing sleeve 105a comprises metal. The nacelle structure 102 comprises composite. However, in other embodiments, any appropriate material can be used.

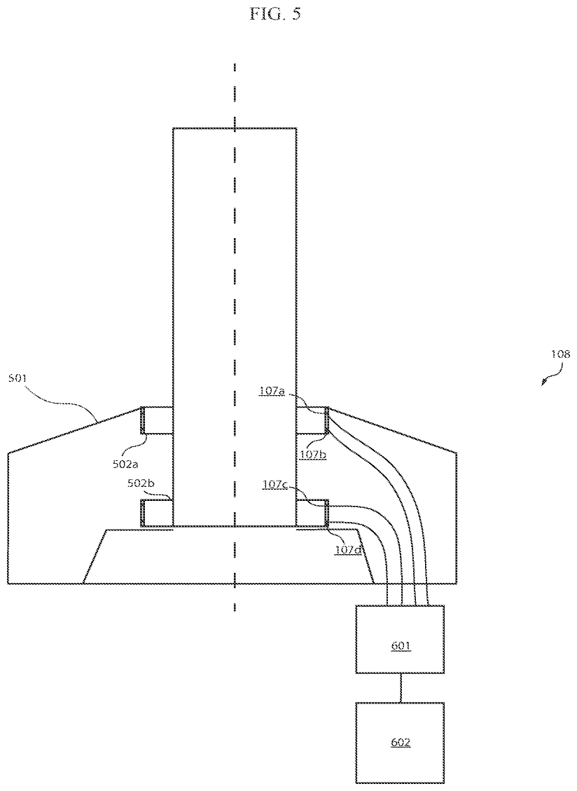

Mast moment sensing system 108—illustrated in FIG. 5—comprises fiber optic cables 107a, 107b, 107c, and 107d. Mast moment sensing system 108 can measure the strain of fiber optic strain sensing cables 107a, 107b, 107c, and 107d. When the fiber optic strain sensing cables 107a, 107b, 107c, and 107d are subjected to forces, measured strain will change as the bearing sleeve 105a and 105b deform. It should be recognized that one skilled in the art can interpret fiber optic strain sensing signals into strain readings.

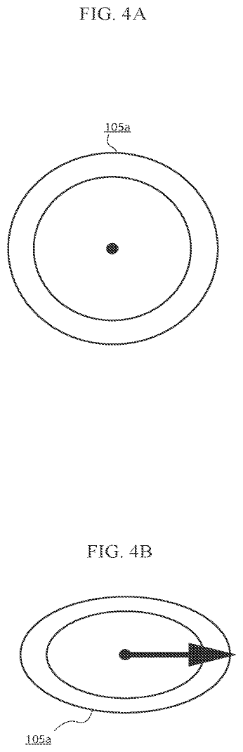

FIG. 4A illustrates a diagram of bearing sleeve 105a in a non-strained state. FIG. 4B illustrates bearing sleeve 105a in a strained state. During a certain mast moment force, a force will deform bearing 103a and bearing sleeve 105a. By measuring the strain, the mast moment can be determined.

The mass moment sensing system 108 of FIG. 5 comprises fiber optic strain sensing sensors 107a, 107b, 107c, and 107d that are configured to measure strain in the vicinity of each of the two main rotor shaft bearings 502a and 502b. The mast moment sensor system measures strain transferred through the two rotor shaft bearings-that are the main source of mast moment transfer between the nacelle structure 104 and the rotor shaft 101.

As opposed to some conventional methods for measuring mast moment, that measured deflection between a first part of the sensor system in the rotating frame and a second part of the sensor system that was in the rotating frame, the sensor system of FIG. 2 is in the non-rotating reference frame. Thus, robustness and simplicity can be achieved.

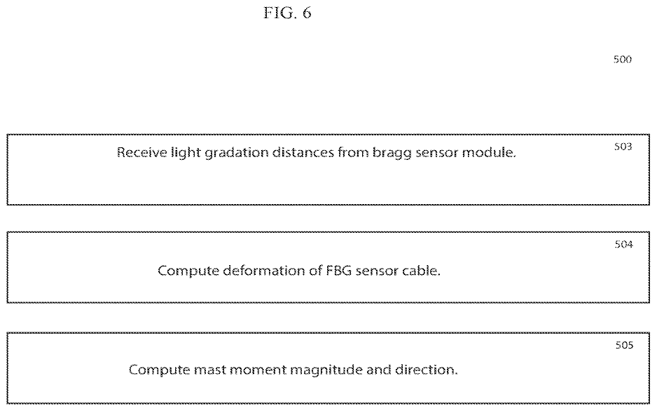

Shown in FIG. 5, are fiber optic strain sensor cables 107a, 107b, 107c, and 107d. FIG. 6 shows a method by which mast moment module 602 determines a mast moment for proprotor 109. Fiber optic strain sensor module 601 receives a set of signals from the first set of fiber optic cables 107a. Then the fiber optic strain sensor module 601 receives a set of light grating reflections from fiber optic strain sensing cable 107a. The fiber optic strain sensor module 601 computes the strain at the gratings on 107a. Fiber optic strain sensor module 601 sends the grating strain information to mast moment module 602. This process is repeated for fiber optic strain sensing cables 107b, 107c, and 107d. Mast moment module 602 uses the determined grating strain information to determine the magnitude and direction of the mast moment. In the embodiment of FIG. 5, the bearings 502a and 502b are located in gearbox 501.

In some embodiments of a mast moment sensing system, the mast moment module may comprise a lookup table of empirically correlated mast moment to bearing sleeve deformation information that can be used to compute the mast moment. Higher resolution fiber optic strain sensor enables a higher resolution bearing deformation map to be generated.

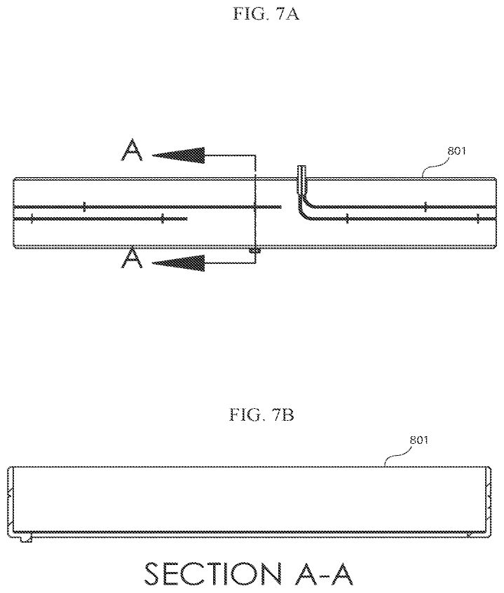

FIG. 7A illustrates a different embodiment of a bearing sleeve 801. In the embodiment of FIG. 7A, the outside of the bearing sleeve 801 is configured for a nacelle structure that is straight (non-tapered) at the bearing sleeve-to-nacelle structure interface.

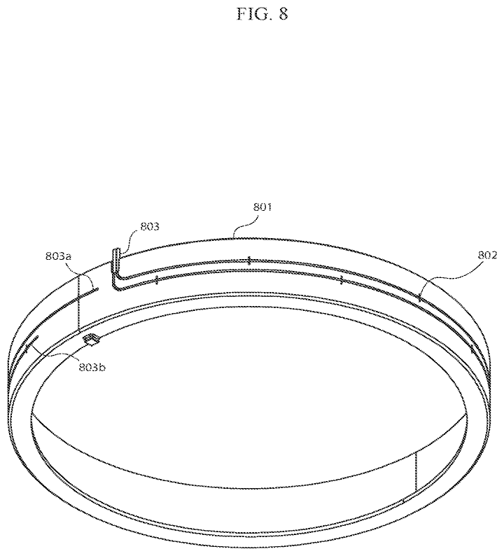

FIG. 8 illustrates bearing sleeve 801. Illustrated is armored fiber optic cable section 803. The armoring protects against environmental damage. The fiber optic cables comprise grating groups 802 spaced about the length of the fiber optic cable. The embodiment of FIG. 8 comprises fiber optic temperature sensors 803a and 803b for calibrating the fiber optic strain readings for the current temperature and weather conditions.

FIG. 7B illustrates a cross section of FIG. 7A FIG. 8 illustrates an isometric view of bearing sleeve 801. Thus, the bearing sleeve very nicely serves as space for the fiber optic strain sensing cable-resulting in very compact mast moment sensor packaging.

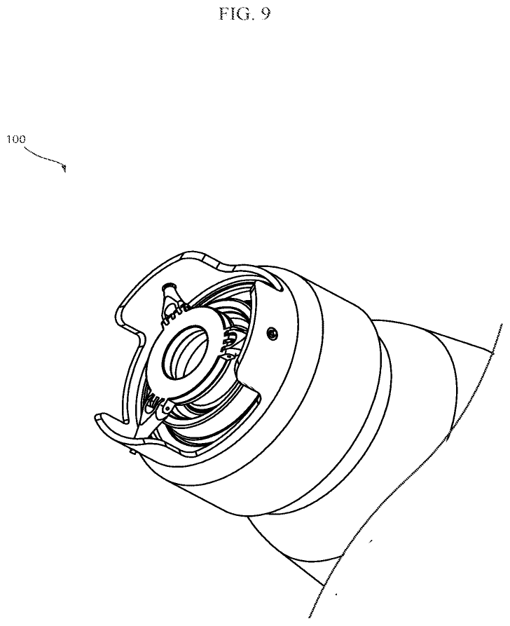

FIG. 9 illustrates an isometric view of aspects of the same proprotor propulsion system as shown in FIG. 1. For clarity, the main proprotor hubs and proprotor blades are not shown.

As illustrated in FIG. 2, the first and second fiber optic strain sensing cable 107a and 107b are fixed relative to the bearing sleeves 105a and 105b. That is, the fiber optic strain sensors 107a and 107b are in the non-rotating portion of the propulsion system assembly. This facilitates integration because wires can be connected to devices in a fuselage without use of a slip ring or similar device.

Fiber optic strain sensors may comprise any suitable fiber optic strain sensor including: Fiber Bragg Grating (FBG) sensors; optical time domain reflectometry sensors; or any other suitable sensors.

The mast moment sensor system results in good mast moment readings. Fiber Bragg Grating (FBG) sensors are both sensitive and robust-enabling consistent and precise measurements.

Mast moment module 602 can use the signals from the fiber optic strain sensor to compute a mast moment load acting on hub shaft 101. The strain information can then be used to determine mast moment.

It should be understood that the fiber optic strain sensor may use grating frequency or local fiber optic material strain to measure strain.

It should be noted that any language directed to a fiber optic strain sensor module, mast moment module, or similar should be read to include any suitable combination of computing devices, including servers, interfaces, systems, databases, agents, peers, engines, controllers, or other types of computing devices operating individually or collectively. The computing devices may comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed above with respect to the disclosed apparatus. In some embodiments, various servers, systems, databases, or interfaces may exchange data using standardized protocols or algorithms, possibly based on HTTP, HTTPS, AES, public-private key exchanges, web service APis, known financial transaction protocols, or other electronic information exchanging methods. Data exchanges preferably are conducted over a packet-switched network, the Internet, LAN, WAN, VPN, or other type of packet switched network.

The term proprotor is used herein for convenience. As used herein, the term proprotor should be understood to include rotor, proprotor, propeller, propulsor, fan, ducted fan, or any other similar device.

It should be recognized by one skilled in the art that the rotor shaft bearings can be of any appropriate type including angular contact bearings, tapered roller bearings, bushings, or any other suitable type of bearings. Furthermore, there can be any number of bearings.

While some embodiments herein are configured for an electric vertical takeoff and landing (eVTOL) aircraft, embodiments of the mast moment sensing system can be equally applicable to other types of aircraft including helicopters, turbine powered tiltrotors, non-tiltrotor VTOL, turbine powered helicopters, or any other type of aircraft.

1-8. (canceled)

9. A system for measuring a mast moment of a component of an aircraft, comprising:
at least two fiber optic strain sensors axially-aligned and separated by an axial distance along the component, wherein each strain sensor is configured to measure strain resulting from a radial load; and
at least one processor configured to receive data from the at least two fiber optic strain sensors and compute the mast moment based on the received data.

10. The system of claim 9, further comprising at least two bearings, each bearing corresponding to at least one fiber optic strain sensor of the at least two fiber optic strain sensors.

11. The system of claim 10, further comprising at least two bearing sleeves, each corresponding to one of the at least two bearings.

12. The system of claim 11, wherein each of the at least two bearing sleeves is configured to accommodate at least one fiber optic strain sensor of the at least two fiber optic strain sensors about a circumference of the bearing sleeve.

13. The system of claim 12, wherein the at least two bearings are interposed between a structure of the aircraft and the component.

14. The system of claim 13, wherein the at least two fiber optic strain sensors are fixed relative to the bearing sleeves.

15. The system of claim 11,
wherein the at least two fiber optic strain sensors comprise four fiber optic strain sensors, and
wherein each of the at least two bearing sleeves accommodates at least two fiber optic strain sensors of the four fiber optic strain sensors.

16. The system of claim 11,
wherein the at least two fiber optic strain sensors comprise eight fiber optic strain sensors, and
wherein each of the at least two bearing sleeves accommodates at least four fiber optic strain sensors of the eight fiber optic strain sensors.

17. The system of claim 10, wherein at least one of the at least two bearings is a proprotor shaft bearing.

18. The system of claim 10, wherein at least one of the at least two bearings is a hub shaft bearing.

19. The system of claim 9, wherein the computed mast moment comprises a magnitude and a direction of the mast moment.

20. The system of claim 9, further comprising two temperature sensors, each temperature sensor associated with one of the at least two fiber optic strain sensors.

21. The system of claim 20, wherein the at least one processor is further configured to compute the mast moment based on data received from the two temperature sensors.

22. The system of claim 9, wherein computing the mast moment comprises referencing a look up table that correlates mast moment to deformation.

23. The system of claim 9, wherein each of the at least two fiber optic strain sensors comprises a section of armored fiber optic cable.

24. The system of claim 9, wherein at least one of the at least two fiber optic strain sensors is a fiber Bragg grating type sensor.

25. The system of claim 9, wherein at least one of the at least two fiber optic strain sensors is an optical time domain reflectometry type sensor.

26. The system of claim 9, wherein the at least two fiber optic strain sensors are configured to generate light grating reflections.

27. The system of claim 26, wherein the strain resulting from the radial load acting on the component is computed based on the generated light grating reflections.

28. A method for measuring a mast moment of a component of an aircraft, comprising:
measuring, by at least one first fiber optic sensor at a first location along the component, a first strain resulting from a radial load;
measuring, by at least one second fiber optic sensor at a second location along the component, a second strain resulting from the radial load;
wherein the first location and the second location are axially-aligned and separated by an axial distance along the component; and
computing the mast moment based on the measured first strain and the measured second strain.

29. A non-transitory computer-readable medium configured to execute instructions for measuring a mast moment of a component of an aircraft, the instructions comprising:
measuring, based on an output of at least one first fiber optic sensor at a first location along the component, a first strain resulting from a radial load;
measuring, based on an output of at least one second fiber optic sensor at a second location along the component, a second strain resulting from the radial load;
wherein the first location and the second location are axially-aligned and separated by an axial distance along the component; and
computing the mast moment based on the measured first strain and the measured second strain.
